(19) United States
(12) Patent Application Publication
(10) Pub. No.: US 2013/0148259 A1
(43) Pub. Date: Jun. 13, 2013

(54) CAPACITOR AND METHOD OF MANUFACTURING SAME

(71) Applicants: Hidetoshi Masuda, Tokyo (JP); Kenichi Ota, Tokyo (JP)

(72) Inventors: Hidetoshi Masuda, Tokyo (JP); Kenichi Ota, Tokyo (JP)

(73) Assignee: TAIYO YUDEN CO., LTD., Tokyo (JP)

(21) Appl. No.: 13/807,273

(22) PCT Filed: May 26, 2011
(86) PCT No.: PCT/JP2011/062048

§ 371 Date: Feb. 28, 2013

(30) Foreign Application Priority Data
Jun. 30, 2010 (JP) 2010-150018

(51) Int. Cl. H01G 4/01

(52) U.S. Cl. CPC H01G 4/01
USPC 361/303; 29/25.03

(57) ABSTRACT

One object is to provide a capacitor that can have an improved capacitance value without sacrificing a dielectric breakdown voltage and a method for manufacturing the capacitor, or a capacitor that can have an improved dielectric breakdown voltage without sacrificing the capacitance value and a method for manufacturing the capacitor. In accordance with one aspect, a capacitor includes a porous dielectric layer obtained by metal anodization; columnar electrodes filled into the holes of the dielectric layer; a first external electrode formed on one principal surface of the dielectric layer and electrically conductive to some of the columnar electrodes; and second external electrodes formed on the other principal surface of the dielectric layer and electrically conductive to columnar electrodes not electrically conductive to the first external electrode. The second external electrodes are disposed so as to be electrically isolated from each other.

### TECHNICAL FIELD

The present invention relates to a capacitor and a method of manufacturing the capacitor, and specifically to a capacitor improved in capacitance and breakdown voltage resistance and a method of manufacturing the capacitor.

### BACKGROUND ART

As a technique to make a capacitor high in ratings and capacitance, there is known, for example, the laminated ceramic capacitor described in Japanese Patent Laid-Open No. 7-263270 (Patent Literature 1). FIG. 4 illustrates a cross section of this laminated ceramic capacitor. As illustrated in the figure, a ceramic laminated body 900 includes a lead-out electrode 910 connected to an external electrode 920; and a lead-out electrode 912 formed in the same layer as the lead-out electrode 910 and connected to the external electrode 920. The same lead-out electrodes as the lead-out electrodes 910 and 912 are also formed in other layers.

A floating electrode 930 is formed between the layer in which the lead-out electrodes 910 and 912 are formed and a layer located below that layer. A unitary capacitor unit 940 is formed of this floating electrode 930 and the lead-out electrode 910, and a unitary capacitor unit 942 is formed of the floating electrode 930 and the lead-out electrode 912. As described above, the unitary capacitor units 940 and 942 are connected in series between the external electrode 920 and an external electrode 922. The same floating electrodes as the floating electrode 930 are also formed between other layers. As described above, in the ceramic laminated body 900, laminated capacitors formed of a plurality of lead-out electrodes and a plurality of floating electrodes are connected in series between the external electrodes. The ceramic laminated body 900 is said to be able to improve voltage resistance while suppressing the occurrence of surface leakage.

### CITATION LIST

### Patent Literature

Patent Literature 1: Japanese Patent Laid-Open No. 7-263270

### SUMMARY

In the ceramic laminated body 900 described in Patent Literature 1, however, the number of laminated electrodes, when viewed in the laminating direction of the electrodes (latitudinal direction in FIG. 4), differs in some locations. For example, only five layers of floating electrodes 930 are present in the middle of an element and no lead-out electrodes are present therein. Only four layers of lead-out electrodes are present in the vicinity of the external electrodes 920 and 922, respectively. Both four layers of lead-out electrodes and five layers of floating electrodes 930 are present in locations other than these regions. Accordingly, the thickness of the ceramic laminated body 900 varies depending on the location thereof. Consequently, the distribution of stress arising in the ceramic laminated body 900 is uneven. Uneven stress may result in the occurrence of cracks.

Al electrolytic capacitors and laminated ceramic capacitors have been in widespread use. An Al electrolytic capacitor uses an electrolytic solution, and therefore, has the problem of liquid leakage. A process for manufacturing a laminated ceramic capacitor requires calcination, and therefore, the capacitor has the problem that thermal contraction between an electrode and a dielectric material occurs in a calcination process. As a technology to cope with these problems, a capacitor based on porous Al₂O₃ has been proposed recently (see, for example, Japanese Patent Laid-Open No. 2009-88034). The present inventors have found that there is the possibility of being able to remedy such failures as the occurrence of cracks in the above-described capacitor of lamination type by utilizing the porous capacitor described above.

According to one embodiment of the present invention, there is provided a capacitor that can have an improved capacitance value without sacrificing a dielectric breakdown voltage and a method for manufacturing the capacitor, as well as a capacitor that can have an improved dielectric breakdown voltage without sacrificing the capacitance value and a method for manufacturing the capacitor.

A capacitor according to one embodiment of the present invention is provided with a dielectric layer including first and second principal surfaces formed substantially parallel to each other and a plurality of holes formed so as to be substantially orthogonal to the first and second principal surfaces; a plurality of columnar electrodes formed by filling a conductive material into the plurality of holes; a first external electrode formed on the first principal surface of the dielectric layer, so as to electrically conduct to some of the plurality of columnar electrodes; and a second external electrode formed on the second principal surface of the dielectric layer, so as to electrically conduct to the others of the plurality of columnar electrodes, the others of the plurality of columnar electrodesnot being electrically conductive to the first external electrode, wherein at least one of the first and second external electrodes is composed of a plurality of electrical conductor units electrically isolated from each other.

A capacitor manufacturing method according to one embodiment of the present invention includes the steps of: preparing a base material for valve metal including first and second principal surfaces formed substantially parallel to each other; anodizing the base material to form a dielectric layer in which a plurality of holes substantially orthogonal to the first and second principal surfaces is formed; filling a conductive material into the plurality of holes in the dielectric layer to form a plurality of columnar electrodes; forming, on the first principal surface, a first external electrode electrically conductive to some of the plurality of columnar electrodes; and forming, on the second principal surface, a second external electrode electrically conductive to the others of the plurality of columnar electrodes, the others of the plurality of columnar electrodes not being electrically conductive to the first external electrode, wherein at least one of the first and second external electrodes is formed so as to be electrically isolated from each other.

Objects, features, and advantages of the present invention will become apparent from the following detailed description taken in conjunction with the accompanying drawings.

### Advantageous Effects

According to one embodiment of the present invention, there is provided a capacitor that can have an improved capacitance value while maintaining a required dielectric breakdown voltage and a method for manufacturing the capacitor, as well as a capacitor that can have an improved dielectric breakdown voltage while maintaining a required capacitance value and a method for manufacturing the capacitor.

### BRIEF DESCRIPTION OF DRAWINGS

FIG. 1 illustrates a capacitor according to one embodiment of the present invention, wherein FIG. 1A is a cross-sectional view illustrating the laminated structure of the capacitor according to one embodiment of the present invention, FIG. 1B is a perspective view taken by enlarging part of FIG. 1A, and FIG. 1C is a schematic cross-sectional view when a cross section obtained by cutting FIG. 1B along the #A-#A line thereof is viewed from the direction of arrows.

FIG. 2 illustrates a capacitor according to another embodiment of the present invention, wherein FIG. 2A is a cross-sectional view illustrating the laminated structure of the capacitor, FIG. 2B is a perspective view taken by enlarging part of FIG. 2A, and FIG. 2C is a schematic cross-sectional view when a cross section obtained by cutting FIG. 2B along the #B-#B line thereof is viewed from the direction of arrows.

FIG. 3 illustrates a capacitor according to a comparative example, wherein FIG. 3A is a cross-sectional view illustrating the laminated structure of the capacitor of the comparative example, FIG. 3B is a perspective view taken by enlarging part of FIG. 3A, and FIG. 3C is a schematic cross-sectional view when a cross section obtained by cutting FIG. 3B along the #C-#C line thereof is viewed from the direction of arrows.

FIG. 4 is a cross-sectional view illustrating one example of the background art.

FIG. 5 is a schematic view illustrating one example of a process for manufacturing the capacitor according to one embodiment of the present invention.

FIG. 6 is another schematic view illustrating one example of the process for manufacturing the capacitor according to one embodiment of the present invention.

### DESCRIPTION OF EMBODIMENTS

This application claims the right of priority based on Japanese Patent Application No. 2010-150018, titled “Capacitor and Method for Manufacturing Same” and filed on Jun. 30, 2010, the content of which is incorporated herein by reference in its entirety. Hereinafter, a description will be given of modes for carrying out the present invention.

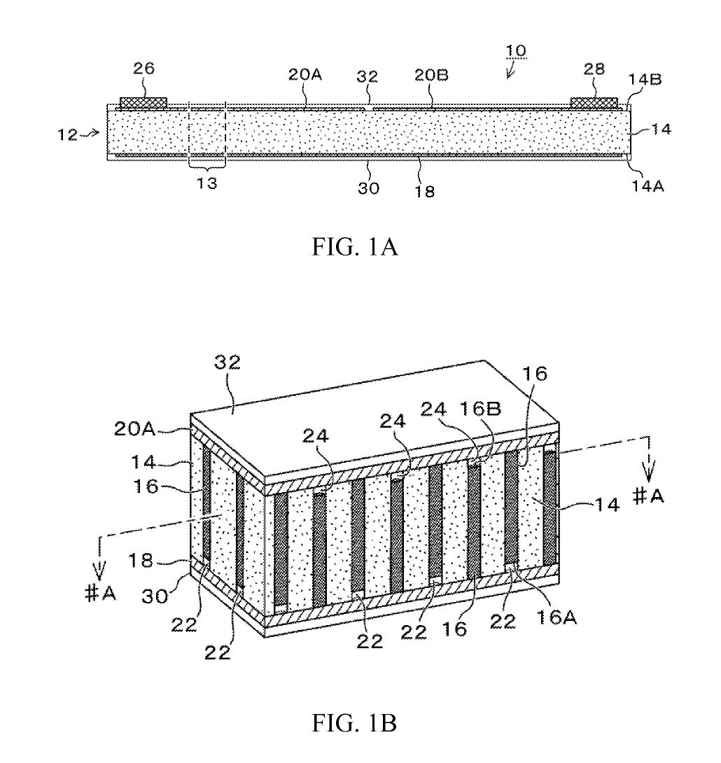

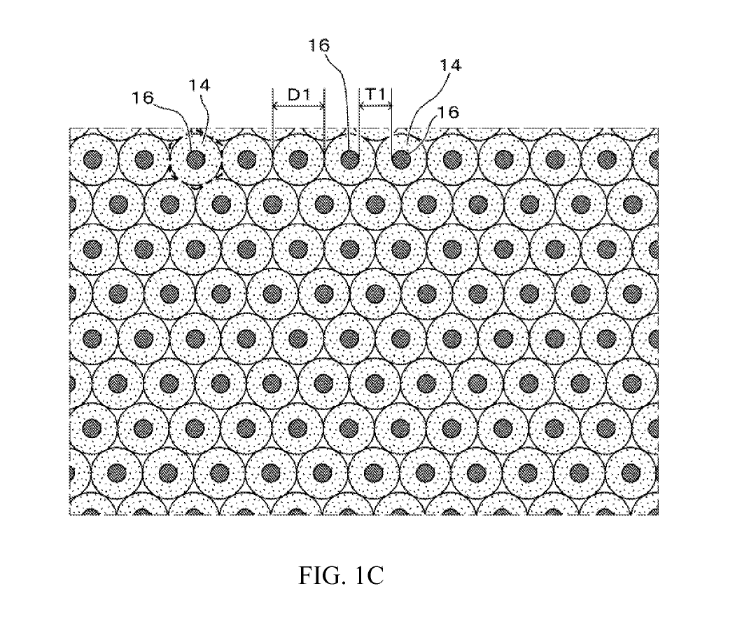

The structure of a capacitor according to one embodiment of the present invention will be described with reference to FIG. 1. FIG. 1A is a cross-sectional view illustrating the laminated structure of the capacitor according to one embodiment of the present invention, FIG. 1B is a perspective view taken by enlarging part of FIG. 1A, and FIG. 1C is a schematic cross-sectional view when a cross section obtained by cutting FIG. 1B along the #A-#A line thereof is viewed from the direction of arrows. A capacitor 10 according to one embodiment of the present invention includes a capacitor element 12, as illustrated in FIG. 1A. The capacitor element 12 includes a dielectric layer 14 composed of a substantially rectangular solid-shaped or substantially sheet-like porous body in which a multitude of holes are formed substantially parallel to each other by metal anodization. The dielectric layer 14 includes a multitude of cells formed by anodizing a base material, such as valve metal, as illustrated in FIG. 1C. Each cell has a bottomed cylindrical shape and includes a hole extending in the thickness direction of the base material, a sidewall surrounding this hole and composed of an oxide of the base material, and a bottom (also referred to as a barrier layer) also composed of the oxide of the base material. This anodization treatment causes surfaces of the base material to be selectively dissolved by the action of an acid. Consequently, this hole is grown toward the thickness direction of the base material by the action of a voltage applied, and oxidized films according to the applied voltage are formed on the surfaces of the base material and the surfaces and bottom of the hole thus formed. In this way, a plurality of cells made of a valve metal oxide and having a bottomed cylindrical shape is formed in the base material. Each cell has a substantially hexagonal shape in plan view. In FIG. 1C, however, the shape of each cell in plan view is shown substantially circular in shape, in order to simply illustrate the size and layout of cells. A conductive material is filled into the multitude of holes formed in the dielectric layer 14. Thus, a multitude of columnar electrodes 16 are formed by this conductive material. The columnar electrodes 16 are randomly sorted into positive and negative electrodes, as shown in Japanese Patent Laid-Open No. 2009-88034 mentioned above. The content of Japanese Patent Laid-Open No. 2009-88034 is incorporated herein by reference in its entirety.

Each columnar electrode 16 is formed so as to be substantially orthogonal to one principal surface 14A of the dielectric layer 14. A first external electrode 18 is formed on this principal surface 14A. The first external electrode 18 is electrically connected to some of the multitude of columnar electrodes 16. In one embodiment, columnar electrodes 16 electrically conductive to the first external electrode 18 function as negative electrodes. Second external electrodes 20A and 20B are formed on the other principal surface 14B of the dielectric layer 14. These second external electrodes 20A and 20B are electrically connected to the others of the columnar electrodes 16, which are not electrically conductive to the first external electrode 18. In one embodiment, columnar electrodes 16 electrically conductive to the second external electrodes 20A and 20B function as positive electrodes. Some of the columnar electrodes 16 (for example, columnar electrodes 16 to function as negative electrodes) and the second external electrodes 20A and 20B are insulated from each other by an insulating cap 24, and the remaining columnar electrodes 16 (for example, columnar electrodes 16 to function as positive electrodes) and the first external electrode 18 are insulated from each other by an insulating cap 22. The second external electrodes 20A and 20B are formed so as to be electrically isolated from each other on the principal surface 14B of the dielectric layer. Consequently, the capacitor 10 has a structure in which capacitance-generating portions of the capacitor are serially connected in two stages as equivalent circuits. The second external electrodes 20A and 20B are connected to external terminals 26 and 28, respectively. In addition, the first external electrode 18 is covered with a protective layer 30. Likewise, the second external electrodes 20A and 20B, except portions thereof on which the external terminals 26 and 28 are provided, are covered with a protective layer 32.

An oxide of valve metal (Al, Ta, Nb, Ti, Zr, Hf, Zn, W, Sb, or the like), for example, is used as the material of the dielectric layer 14. The external electrodes 18, 20A and 20B and the external terminals 26 and 28 are composed of, for example, metal such as Cu, Ni, Cr, Ag, Au, Pd, Fe, Sn, Pb, Pt, Ir, Rh, Ru or Al, solder made therefrom, and/or a material formed by laminating these types of metal or solder. Platable metal, such as Cu, Ni, Co, Cr, Ag, Au, Pd, Fe, Sn, Pb or Pt, and/or an alloy thereof, for example, is used as the material of the columnar electrodes 16. The insulating caps 22 and 24 are composed of, for example, an oxide of valve metal, such as Al, Ta, Nb, Ti, Zr, Hf, Zn, W or Sb, an air gap, electrodeposited resin, such as polyimide, epoxy or acrylic, electrodeposited TiO₂, or electrodeposited SiO₂. The protective layers 30 and 32 are composed of, for example, SiO₂, SiN, resin, or metal oxide.

The distance between the first external electrode 18 and each of the second external electrodes 20A and 20B (i.e., the thickness of the dielectric layer 14) is, for example, several 100 nm to several 100 μm, and the thicknesses of the first external electrode 18 and the second external electrodes 20A and 20B are, for example, several 10 nm to several The columnar electrodes 16 are formed so that the diameter thereof is, for example, approximately several 10 nm to several 100 nm, the length thereof is, for example, approximately several 100 nm to several 100 μm, and the distance between adjacent columnar electrodes 16 is, for example, approximately several 10 nm to several 100 nm. The insulating caps 22 and 24 are formed so that the thickness thereof is, for example, several 10 nm to several 10 μm. The protective layers 30 and 32 are formed so that the thickness thereof is, for example, several 10 nm to several 10 μm.

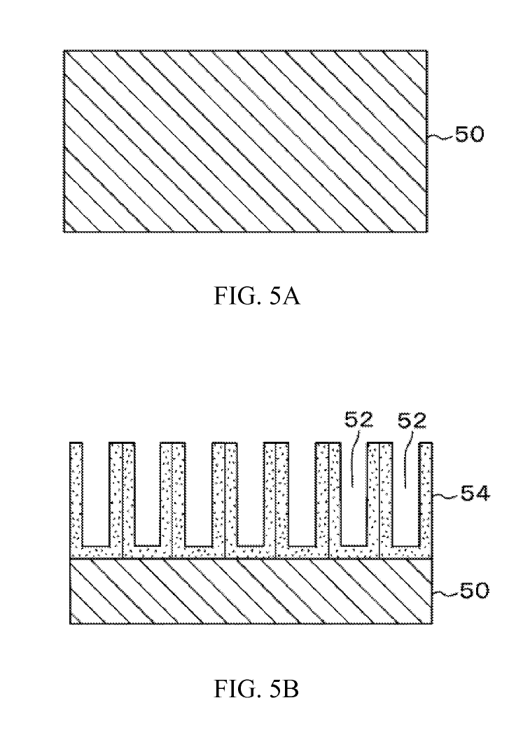

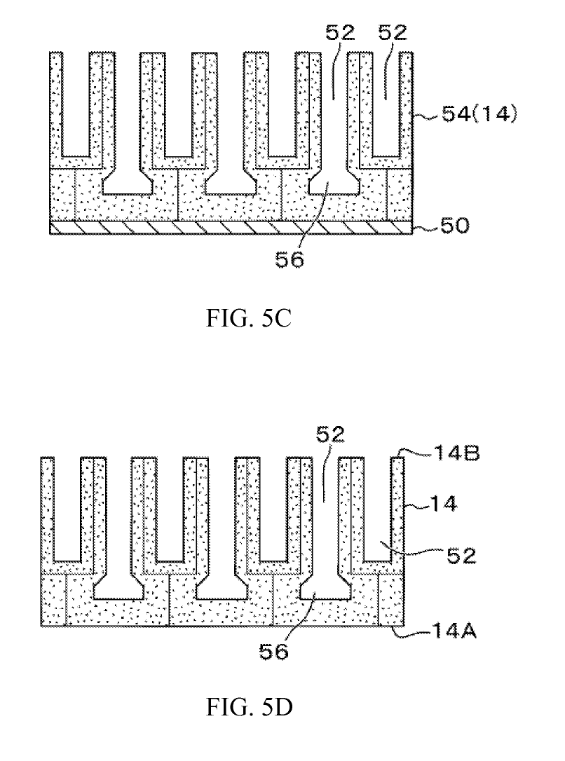

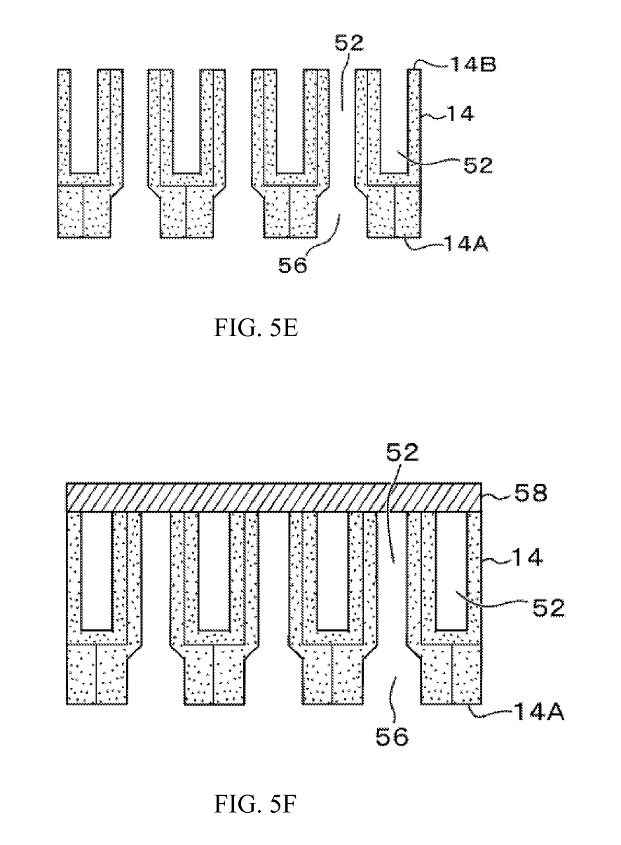

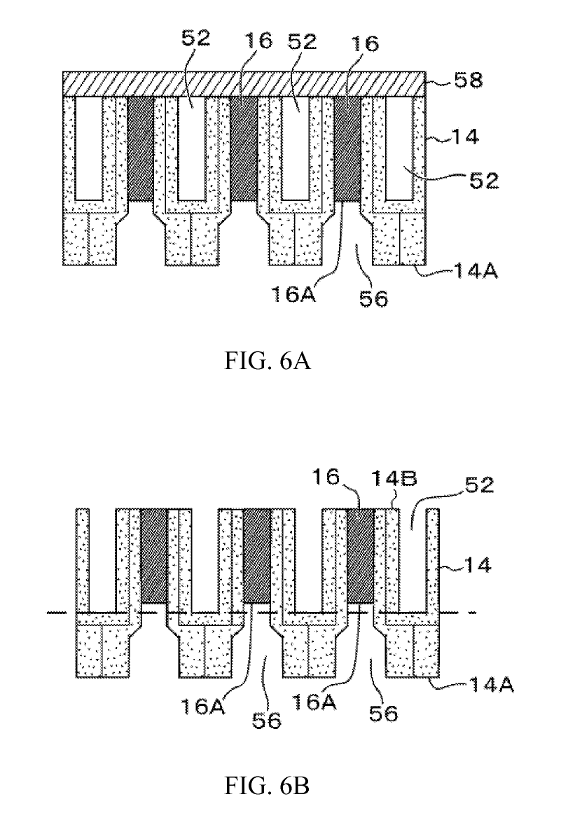

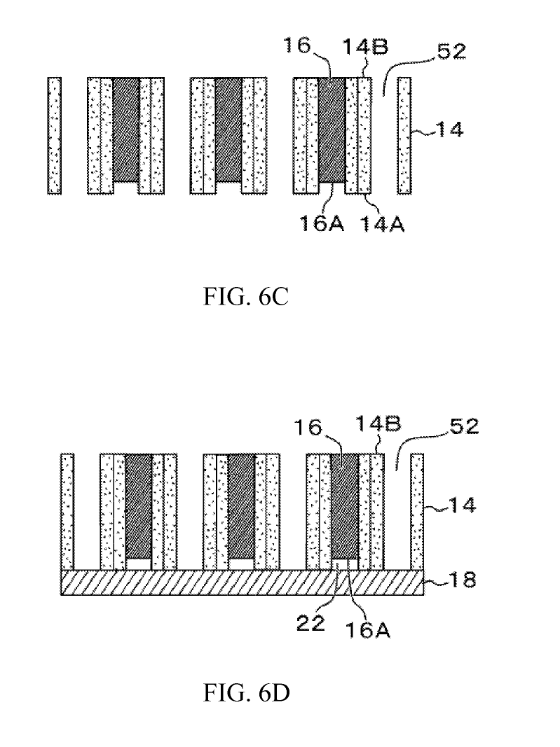

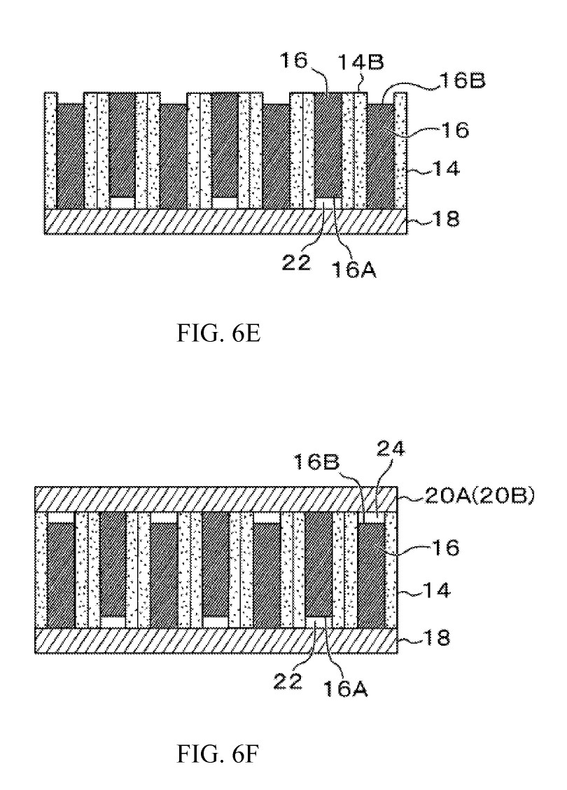

Next, one example of a method for manufacturing the capacitor 10 according to one embodiment of the present invention will be described with reference to FIGS. 5 and 6. First, as illustrated in FIG. 5A, there is prepared a base material 50 made of valve metal, such as Al, Ta, Nb, Ti, Zr, Hf, Zn, W or Sb. A predetermined voltage is applied to this metal base material 50 to perform an anodization treatment thereon. Consequently, a plurality of first holes 52 having a desired depth (length) is formed in the thickness direction of the metal base material 50, as illustrated in FIG. 5B. Surfaces of the base material 50 are oxidized by this anodization treatment and, consequently, the sidewall and bottom surface of each hole 52 are composed of oxides of valve metal substantially the same in thickness. Next, an anodization treatment is performed on the base material 50 by using a voltage higher than the voltage used when the first holes 52 are formed. Consequently, second holes 56 are formed in the bottom surfaces of some of the first holes 52, as illustrated in FIG. 5C, and the base material 50 is oxidized, except some regions in the vicinity of the lower surface of the base material. Since the pitch of holes (distance between holes) produced by anodization is proportional to a voltage, the second holes 56 are formed only in some of the first holes 52 rather than in all thereof. The dielectric layer 14 is composed of an oxide of valve metal obtained by the first and second stages of anodization treatment.

In one embodiment, the first-stage anodization treatment illustrated in FIG. 5B is performed under the conditions of an applied voltage of several V to several 100 V and a treating time of several minutes to several days. The second-stage anodization treatment illustrated in FIG. 5C is performed under the conditions of a voltage value several times the first-stage voltage value and a treating time of several minutes to several 10 minutes. If the first-stage voltage applied is 20 V, for example, then the pitch of the first holes 52 is approximately 50 nm. If the second-stage voltage applied is 40 V, then the pitch of the second holes 56 is 100 nm. By setting the second-stage voltage value to approximately twice the first-stage voltage value, first holes 52 in which second holes 56 are formed and first holes 52 in which second holes 56 are not formed can be made almost the same in number. In addition, since the treating time of the second-stage anodization is on the order of several minutes to several 10 minutes, the thickness of an oxide base material 54 formed in the second stage can be made smaller. The oxide base material 54 formed in the second stage is removed in a later-describe post-process and is, therefore, desired to be as thin as possible.

Next, the bare metal portions of the metal base material 50 (portions not oxidized by anodization treatment) are removed as illustrated in FIG. 5D. Subsequently, the lower-side portions of the second holes 56 of the oxide base material 54 (dielectric layer 14) are cut off to open up the second holes 56 from one principal surface 14A of the dielectric layer 14, as illustrated in FIG. 5E. Next, as illustrated in FIG. 5F, a seed layer 58 made of a conductive material is formed on the other principal surface 14B of the dielectric layer 14 by a PVD method. Next, a plated conductor is filled into first holes 52 connected to the second holes 56 with the seed layer 58 as a seed, as illustrated in FIG. 6A, thereby forming columnar electrodes 16. Since the ends of first holes 52 not connected to the second holes 56 are closed at this time, the plated conductor is not filled into the first holes. Note that this plated conductor is filled so that ends 16A of the columnar electrodes 16 do not reach the second holes 56. Consequently, a gap is formed between the end 16A of each columnar electrode 16 and the upper end of each second hole 56. In one embodiment, this gap (air gap) is utilized as an insulating cap 22. In another embodiment, an insulating cap composed of a material other than air may be formed between the end 16A of each columnar electrode 16 and the upper end of each second hole 56 by means of anodization, oxide electrodeposition, resin electrodeposition or the like after the step illustrated in FIG. 6A.

Next, the seed layer 58 is removed and the dielectric layer 14 is cut off at a position shown by a dotted line (near the upper end of each second hole 56), as illustrated in FIG. 6B, thereby opening up the ends of first holes, among the first holes 52, in which the columnar electrodes 16 are not formed, as illustrated in FIG. 6C. Next, as illustrated in FIG. 6D, a first external electrode 18 is formed on the principal surface 14A of the dielectric layer by a PVD method or the like. Then, a plated conductor is filled into holes, among the first holes 52, in which the columnar electrodes 16 are not formed, with this first external electrode 18 as a seed, as illustrated in FIG. 6E, thereby forming the remaining columnar electrodes 16. At this time, the plated conductor is filled so that ends 16B of the columnar electrodes do not reach the principal surface 14B of the dielectric material. Consequently, a gap is formed between the end 16B of each columnar electrode 16 and the open end of each first hole 52. This gap (air gap) is utilized as an insulating cap 24 for insulating a second external electrode 20A to be described in detail hereafter and the end 16B of each columnar electrode from each other. In one embodiment, an insulating cap composed of a material other than air may be formed between the end 16B of each columnar electrode 16 and the open end of each first hole 52 by means of anodization, oxide electrodeposition, resin electrodeposition or the like.

Next, as illustrated in FIG. 6F, the second external electrode 20A is formed on the principal surface 14B of the dielectric layer. Consequently, there is obtained a capacitor element 12 in which some electrodes, among a multitude of columnar electrodes 16, are electrically conductive to the first external electrode 18, and the rest of the columnar electrodes 16 is electrically conductive to the second external electrode 20A. Although omitted in FIGS. 5 and 6, a second external electrode 20B electrically isolated from the second external electrode 20A is formed on the principal surface 14B of the dielectric material at the same time as the second external electrode 20A. Next, the external terminals 26 and 28 illustrated in FIG. 1A are formed in the second external electrodes 20A and 20B, respectively. In addition, the portions of the capacitor element 12 other than the external terminals 26 and 28 are covered with protective layers 30 and 32, thereby obtaining a capacitor 10 in which capacitance-generating portions are serially connected in two stages.

If Al is used as the metal base material 50, Al is anodized and a porous dielectric layer 14 made of porous Al₂O₃ is obtained. This porous dielectric layer 14 includes a multitude of cells substantially hexagonal in cross-sectional view (a circular cell is shown by a dotted line, however, in FIG. 1C for the convenience of illustration). The size of these cells is known to be proportional to an anodization voltage, and is approximately 2.5 nm/V in diameter. That is, if a voltage used in anodization treatment is 1 V, then the diameter of each cell is approximately 2.5 nm. In one embodiment, the dielectric thickness T1 of each capacitance-generating portion (distance between the surfaces of adjacent columnar electrodes 16) in a capacitor structure is approximately ⅔ times as large as a cell size D1, as illustrated in FIG. 1C. If, for example, an anodization treatment is performed at 20 V, then the cell size D1 is approximately 50 nm and the dielectric thickness T1 is approximately 33 nm.

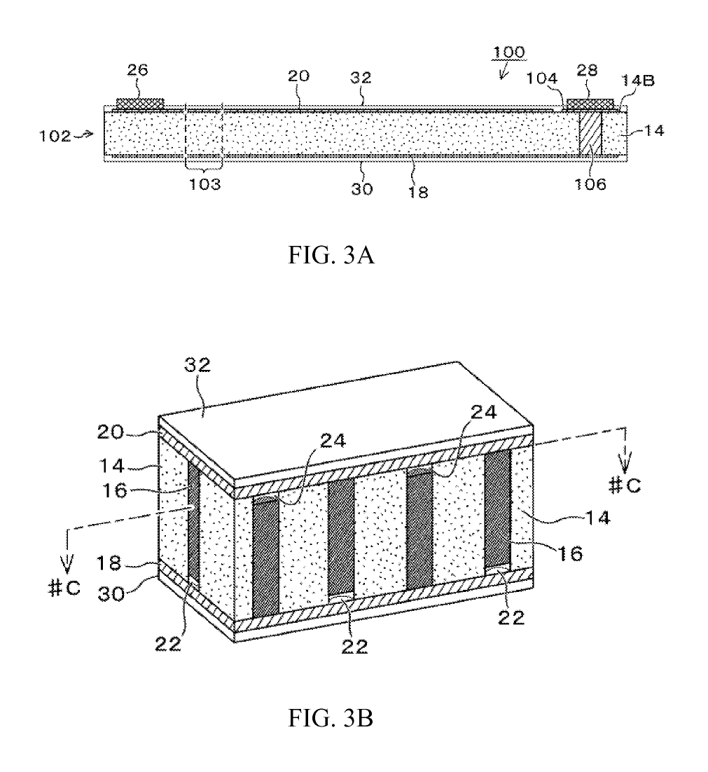

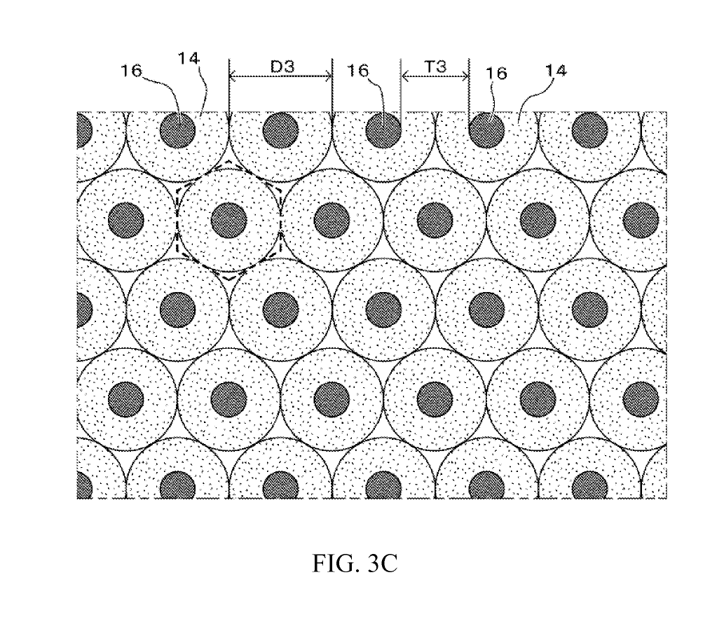

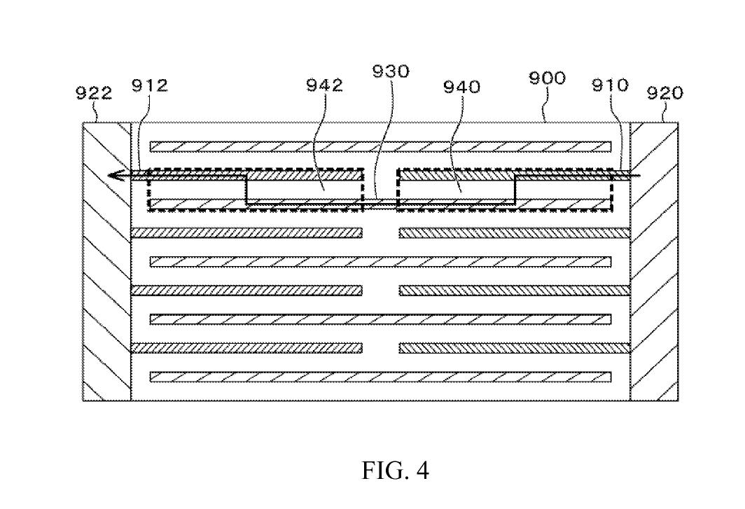

Next, a comparative example will be described with reference to FIGS. 3A to 3C. FIG. 3A is a cross-sectional view illustrating the laminated structure of a capacitor 100 according to the comparative example, FIG. 3B is a perspective view taken by enlarging part of FIG. 3A, and FIG. 3C is a schematic cross-sectional view when a cross section obtained by cutting FIG. 3B along the #C-#C line thereof is viewed from the direction of arrows. The capacitor 100 has the same structure as the capacitor 10, except that the second external electrode 20 is composed of a single conductive material and the external electrode 28 is connected to the first external electrode 18. Thus, the capacitor 100 is formed using the same process as used for the capacitor 10. In a process for manufacturing the capacitor 100, the voltage of first-stage anodization is set to, for example, 40 V. Consequently, the cell size D3 of each cell is 100 nm and the dielectric thickness T3 of each capacitance-generating portion is approximately 66 nm. The second-stage anodization treatment is performed using a voltage higher than the voltage used in the first-stage anodization treatment. The first external electrode 18 is connected to a connection land 104 formed on the principal surface 14B of the dielectric layer by a connecting conductor 106 penetrating through the dielectric layer 14. The first external electrode 18 is led out from the same surface as the surface of the second external electrode 20 by the external terminal 28 provided in the connection land 104.

Next, a description will be given of the capacitance and dielectric breakdown voltage of a capacitor according to one embodiment of the present invention. As described above, in the capacitor according to one embodiment of the present invention, the thickness of the dielectric layer of a unit capacitor (configured into a columnar electrode-dielectric layer-columnar electrode structure) composing the capacitor varies according to the anodization voltage used in the first-stage anodization treatment. Accordingly, the capacitance and dielectric breakdown voltage of the capacitor depend on the anodization voltage used in the first-stage anodization treatment. For example, the dielectric thickness (the thickness of a portion of the dielectric layer 14 present between columnar electrodes 16) of the capacitor manufactured by performing the first-stage anodization treatment using an anodization voltage half the anodization voltage used in the manufacture of the capacitor 100 of the comparative example is half the dielectric thickness of the capacitor 100 of the comparative example. Accordingly, the capacitance of the capacitor is doubled and the dielectric breakdown voltage thereof is halved. In addition, since the cell size (refers to the size of a cell in plan view, and D1 in FIG. 1 denotes one example of the size) varies according to an anodization voltage, the number of cells per unit area also varies according to the anodization voltage. As a result, capacitance per unit area can be varied even if the thickness of an element (corresponding to a distance between the first external electrode 18 and the second external electrode 20) is constant. For example, a capacitor manufactured by setting the anodization voltage to half the voltage used in the manufacture of the capacitor 100 of the comparative example is halved in cell size and quadrupled in the number of cells per unit area, compared with the capacitor 100 of the comparative example. As a result, the capacitance per unit area of the capacitor is quadrupled, compared with the capacitor 100 of the comparative example. As described above, the dielectric thickness and the number of cells per unit area of a capacitor can be adjusted by the anodization voltage. For example, a capacitor the capacitance per unit area of which is octupled and the dielectric breakdown voltage of which is halved can be obtained by halving the anodization voltage, compared with the anodization voltage used for the capacitor 100 of the comparative example, in a case where the thickness of an element is kept constant.

Serially connecting capacitors (may in some cases be referred to as “element capacitors” in the present specification) manufactured using an anodization voltage half the anodization voltage used in the manufacture of the capacitor 100 of the comparative example in two stages causes the combined capacitance of the series-connected capacitors to be 4 times (8 times×½) the capacitance of the capacitor 100 of the comparative example and the total volume of the capacitors to be twice the volume of the capacitor 100 of the comparative example. In order to prevent volume increase due to series connection, the volume of element capacitors to be connected should be set to half the volume of the capacitor 100 of the comparative example. Since the capacitance of each element capacitor is proportional to the volume thereof, the capacitance of element capacitors obtained by serially connecting the capacitors each having a volume half the volume of the capacitor 100 of the comparative example in two stages is twice the capacitance of the capacitor 100 of the comparative example 2 (4 times×½). As described above, a capacitor the same in volume as the capacitor 100 of the comparative example but having capacitance twice the capacitance thereof can be obtained by serially connecting, in two stages, the element capacitors manufactured using an anodization voltage half the anodization voltage used in the manufacture of the capacitor 100 of the comparative example. In addition, since a voltage applied to each element capacitor of the series-connected capacitors is half the full voltage, each capacitor in which element capacitors are serially connected has the same dielectric breakdown resistance as the capacitor 100 of the comparative example. As described above, a capacitor having the same dielectric breakdown resistance as the capacitor 100 of the comparative example and capacitance twice the capacitance thereof can be obtained, while maintaining the same volume as that of the capacitor 100, by serially connecting, in two stages, the element capacitors manufactured using an anodization voltage half the anodization voltage used in the manufacture of the capacitor 100 of the comparative example.

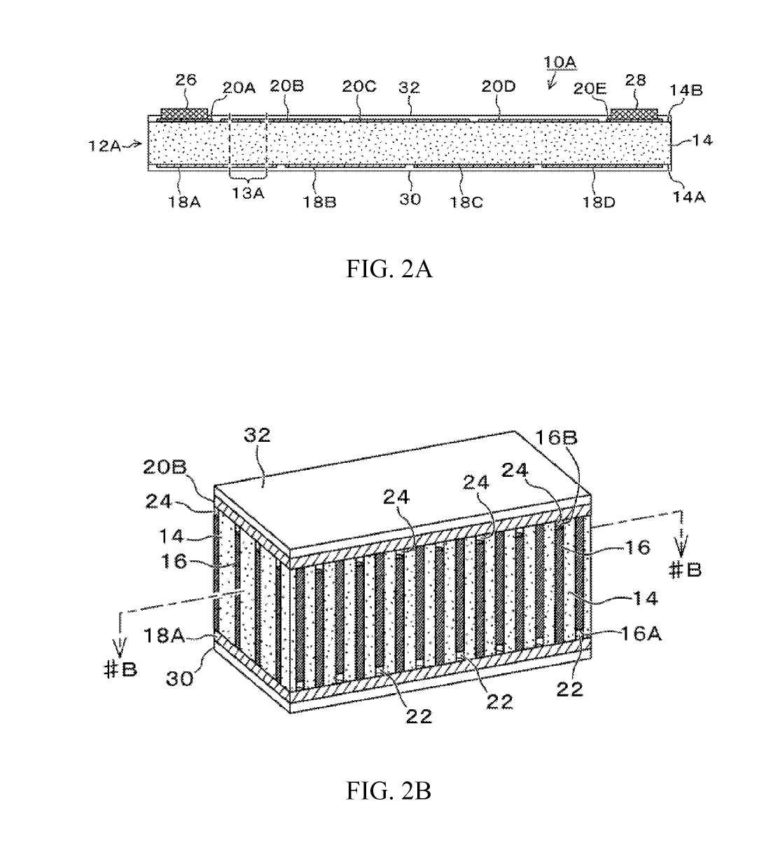

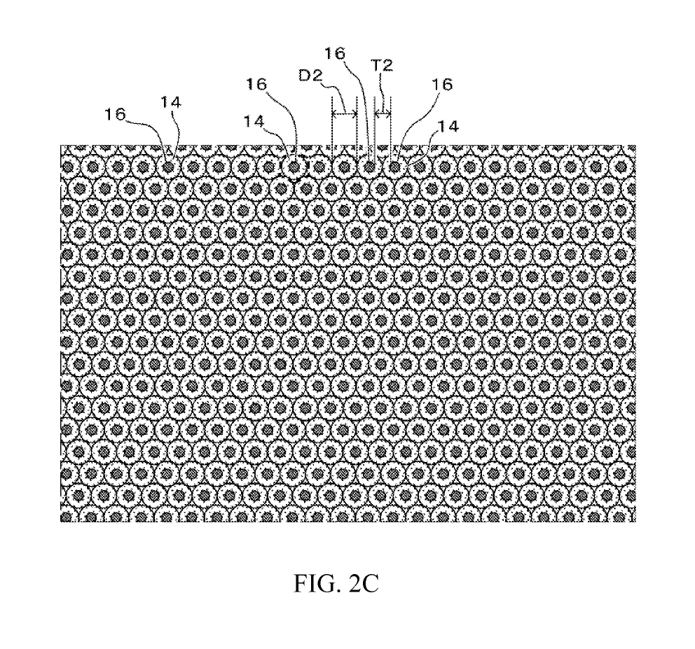

FIG. 2 illustrates a capacitor 10A according to another embodiment of the present invention. The capacitor 10A has the same volume (element volume) as the capacitor 10. FIG. 2A is a cross-sectional view illustrating the laminated structure of the capacitor 10A, FIG. 2B is a perspective view taken by enlarging part of FIG. 2A, and FIG. 2C is a schematic cross-sectional view when a cross section obtained by cutting FIG. 2B along the #B-#B line thereof is viewed from the direction of arrows. The capacitor 10A includes first external electrodes 18A to 18D formed on one principal surface 14A of an element and electrically isolated from each other, and second external electrodes 20A to 20E formed on the other principal surface 14B and electrically isolated from each other, thus having an eight-stage series-connected structure. That is, a first element capacitor is composed of columnar electrodes 16 and a portion of the dielectric layer 14 present in the region between the first external electrode 18A and the second external electrode 20A, and a second element capacitor is composed of columnar electrodes 16 and a potion of the dielectric layer 14 present in the region between the second external electrode 20A and the first external electrode 18B. Likewise, first to eighth element capacitors are composed of columnar electrodes 16 and portions of the dielectric layer 14 present between the first external electrodes 18A to 18D and the second external electrodes 20A to 20E, respectively. Since external terminals 26 and 28 are connected to the second external electrodes 20A and 20E, respectively, the first to eighth element capacitors are directly connected between the external terminal 26 and the external terminal 28. The capacitor 10A is manufactured using basically the same process as used for the capacitor 10, except the voltage value used in anodization treatment. In the manufacturing process for the capacitor 10A, a first-stage anodization treatment is performed using a voltage of, for example, 10 V (corresponding to ¼ times the voltage used in the manufacturing process for the capacitor 100). As described above, the dielectric breakdown voltage can be doubled (¼ times×8 time) by performing an anodization treatment at a voltage ¼ times the anodization voltage used in the manufacturing process of the capacitor 100 to obtain eight stages of series connection, while maintaining capacitance (64 times× 1/64 times) with the volume of the element left intact.

Advantageous effects of the present invention were verified using the capacitor 100 of the comparative example as a reference. The capacitor 100 of the comparative example was formed by setting an anodization voltage used in the first-stage anodization treatment to 40 V, so that the size of the capacitor was 1 mm×0.5 mm×0.1 mm. The capacitance value of this capacitor 100 was 0.5 μF and the dielectric breakdown voltage thereof was 10 V. On the other hand, the capacitance value of the capacitor 10 according to one embodiment of the present invention configured by serially connecting element capacitors formed at the first-stage anodization voltage of 20 V in two stages was 1 μF, and the dielectric breakdown voltage of the capacitor was 10 V. As described above, it was confirmed that the capacitor 10 according to one embodiment of the present invention had capacitance twice as large as that of the capacitor 100 of the comparative example, while maintaining the same volume and the same dielectric breakdown resistance as those of the capacitor 100.

The capacitance value of the capacitor 10A according to another embodiment of the present invention configured by serially connecting element capacitors formed at a first-stage anodization voltage of 10 V in eight stages was 0.5 μF, and the dielectric breakdown voltage of the capacitor was 20 V. As described above, it was confirmed that the capacitor 10A according to another embodiment of the present invention had dielectric breakdown voltage twice as large as that of the capacitor 100 of the comparative example, while maintaining the same volume and the same capacitance as those of the capacitor 100.

By applying an even number of stages of series connection as in the capacitors 10 and 10A, the two external terminals 26 and 28 can be formed on the same surface. In addition, an element structure including one each of the external terminals 26 and 28 on the front and rear surfaces, respectively, can be easily attained by adopting a series-connected structure composed of an odd number of stages, though not illustrated, as in the capacitors 10 and 10A. As described above, an external terminal can be provided on a front or rear surface of an element in the case of the capacitors 10 and 10A. Consequently, a mounting area can be made smaller, compared with a laminated ceramic capacitor in which an external terminal has to be provided on a side surface thereof.

As described above, according to capacitors in accordance with various embodiments of the present invention, the capacitance value of a capacitor can be improved without sacrificing dielectric breakdown resistance or the dielectric breakdown resistance can be improved without sacrificing the capacitance value. In the capacitors in accordance with various embodiments of the present invention, a capacitance value and a rated voltage can be easily adjusted by adjusting the anodization voltage and/or the number of stages of series connection. For example, in the capacitors in accordance with various embodiments of the present invention, the capacitance value can be increased and the rated voltage can be decreased, or the capacitance value can be decreased and the rated voltage can be increased through the adjustment of the anodization voltage and/or the number of stages of series connection. In the capacitors in accordance with various embodiments of the present invention, both of two external terminals can be provided on the front surface, or one each of the external terminals can be respectively provided on the front and rear surfaces according to the embodiment of the capacitor in question. In the capacitors in accordance with various embodiments of the present invention, the occurrence of cracks can be prevented by a columnar electrode structure obtained by anodizing valve metal, when compared with such a planar electrode structure as that of a conventional laminated ceramic capacitor. In addition, the capacitors of the present invention are easy to manufacture.

Note that the present invention is not limited to the above-described embodiments, but may be modified in various other ways without departing from the gist of the invention. For example, the shapes and dimensions shown in the present specification are illustrative only and may be modified as appropriate. The materials shown in the present specification are also illustrative only, and various heretofore-known materials may be used instead. For example, various heretofore-known types of anodizable metal may be used, in addition to Al, as the metal base material 50 used to form the dielectric layer 14. The anodization voltages and the numbers of (numbers of stages of) element capacitors to be serially connected shown in the present specification are also illustrative only. Alternatively, an anodization voltage and the number of stages may be adjusted so as to satisfy capacitance and rated voltage requirements. The electrode lead-out structures shown in the present specification are also illustrative only, but may be design-changed as appropriate. The manufacturing processes shown in the present specification are also illustrative only, but may be modified as appropriate. For example, either the first external electrode 18 or the second external electrodes 20A and 20B may be formed first.

According to capacitors in accordance with various embodiments of the present invention, there are provided a capacitor that can have an improved capacitance value without sacrificing a dielectric breakdown voltage and a method for manufacturing the capacitor, or a capacitor that can have an improved the dielectric breakdown voltage without sacrificing the capacitance value and a method for manufacturing the capacitor.

### REFERENCE SIGNS LIST

10, 10A: Capacitor

12, 12A: Capacitor element

14: Dielectric layer

14A, 14B: Principal surface

16: Columnar electrode

16A, 16B: End

18, 18A to 18D: First external electrode

20, 20A to 20E: Second external electrode

22, 24: Insulating cap

26, 28: External terminal

30, 32: Protective layer

50: Metal base material

52: First hole

54: Oxide base material

56: Second hole

58: Seed layer

100: Capacitor

102: Capacitor element

104: Connection land

106: Connecting conductor

900: Ceramic laminated body

910, 912: Lead-out electrode

920, 922: External electrode

930: Floating electrode

940, 942: Unitary capacitor unit

What claimed is:

1. A capacitor comprising:
a dielectric layer including first and second principal surfaces formed substantially parallel to each other and a plurality of holes formed so as to be substantially orthogonal to the first and second principal surfaces;
a plurality of columnar electrodes formed by filling a conductive material into the plurality of holes;
a first external electrode formed on the first principal surface of the dielectric layer, so as to electrically conduct to some of the plurality of columnar electrodes, the first external electrode being composed of a plurality of electrical conductor units electrically isolated from each other ; and
a second external electrode formed on the second principal surface of the dielectric layer, so as to electrically conduct to the others of columnar electrodes, the others of the plurality of columnar electrodes not being electrically conductive to the first external electrode, the second external electrode being composed of a plurality of electrical conductor units electrically isolated from each other.

2. A capacitor manufacturing method comprising the steps of:
preparing a base material for valve metal including first and second principal surfaces formed substantially parallel to each other;
anodizing the base material to form a dielectric layer in which a plurality of holes substantially orthogonal to the first and second principal surfaces is formed;
filling a conductive material into the plurality of holes of the dielectric layer to form a plurality of columnar electrodes;
forming, on the first principal surface, a first external electrode electrically conductive to some of the plurality of columnar electrodes, the first external electrode being composed of a plurality of electrical conductor units electrically isolated from each other; and
forming, on the second principal surface, a second external electrode electrically conductive to the others of the plurality of columnar electrodes, the others of the plurality of columnar electrodes not being electrically conductive to the first external electrode, the second external electrode being composed of a plurality of electrical conductor units electrically isolated from each other.

3. The capacitor of claim 1, wherein the number of the electrical conductor units composing the first external electrode is one larger than the number of the electrical conductor units composing the second external electrode.

4. The capacitor of claim 3, wherein each of the electrical conductor units composing the second external electrode partially faces two of the electrical conductor units composing the first external electrode.

5. The capacitor of claim 3, wherein the number of the electrical conductor units composing the first external electrode is even.

6. The capacitor of claim 3, wherein the number of the electrical conductor units composing the first external electrode is odd.
